(19) United States
(12) Patent Application Publication
(10) Pub. No.: US 2006/0040096 A1
(43) Pub. Date: Feb. 23, 2006

(54) Constrained layer, composite, acoustic damping material

(76) Inventors: Rajan Eadara, Ann Arbor, MI (US); Roy Jacob, Troy, MI (US); Anthony Konovaliv, Plymouth, MI (US); Arnold Joseff, Bloomfield Hills, MI (US); Biju Philip, Sterling Heights, MI (US)

Correspondence Address: GIFFORD, KRASS, GROH, SPRINKLE & CITKOWSKI, P.C, PO BOX 7021, TROY, MI, 48007-7021, US

(21) Appl. No.: 11/207,160

(22) Filed: Aug. 18, 2005

Related U.S. Application Data
(60) Provisional application No. 60/602,811, filed on Aug. 19, 2004.

(51) Int. Cl. B32B 7/02

(52) U.S. Cl. 428/212

(57) ABSTRACT

A constrained layer, composite structure for damping acoustic vibrations includes an extensional layer comprised of a first polymeric material, and a constraining layer of a second polymeric material. The modulus of elasticity of the constraining layer is greater than that of the extensional layer. In use, the structure is disposed on the surface of an article in which acoustic vibrations are to be damped so that the extension layer overlies the surface. Also disclosed are methods for preparing the structure, including automated methods.

### RELATED APPLICATION

This application claims priority of U.S. Provisional Patent Application Ser. No. 60/602,811 filed Aug. 19, 2004, entitled “Constrained Layer, Composite, Acoustic Damping Material.”

### FIELD OF THE INVENTION

This invention relates generally to structures for damping acoustic vibrations. More specifically, the invention relates to composite damping structures fabricated from organic polymeric materials.

### BACKGROUND OF THE INVENTION

Motor vehicles, electrical appliances, heating, ventilating and air conditioning systems, and similar structures include sheet metal members. The sheet metal members are very efficient in transmitting acoustic vibrations and, in many instances, can be a source of acoustic vibrations; hence, systems including sheet metal members often present significant noise control problems. Consequently, sound absorbing materials are often included in such structures for purposes of noise control.

Sheet metal components of motor vehicles frequently have sound absorbing patches applied thereto. These patches include an adherent, vibration dampening material. One embodiment of such patches comprises an adhesively adherent body of a rubbery polymeric material having a metal foil coating on one face thereof. The rubbery material is adhered to portions of a motor vehicle body, such as the inner surfaces of door panels, roof panels, and the like. Such prior art sound deadening patches must be affixed to the vehicle, typically following various assembly and processing operations, since patches of this type cannot generally survive operations such as dip-coating, painting, heating, and the like. Consequently, these patches must be applied during late stages of the vehicle's assembly when the locations to which the patches are to be applied are not readily accessible to mechanized systems; therefore, these patches must be manually applied. Manual application is expensive, particularly when locations are ergonomically difficult to access. As a consequence, patch placement is often inaccurate; hence, the industry typically employs oversized patches to assure that proper coverage of vibrational nodes is achieved. These oversized patches increase material cost. Also, manual placement frequently results in improper adhesion of the patch to the metal article. As a result, some, or all, portions of the patch may delaminate from the surface, thereby resulting in loss of sound deadening ability.

It will be appreciated from the foregoing that there is a need for improved materials and methods for providing sound deadening in motor vehicles and other such sheet metal structures. As will be explained in detail hereinbelow, the present invention provides a composite sound deadening patch which is highly efficient in function and amenable to automated application techniques. The materials comprising the patch of the present invention may be dispensed in a paste or semisolid, pumpable form which allows for use of high-speed, robotically controlled coating techniques. The patch structure of the present invention provides superior acoustic attenuation. Furthermore, the materials comprising the patch are compatible with processing techniques such as painting, dip-coating, oven baking, and the like. Hence, the patch of the present invention may be applied at early stages in the manufacturing process, thereby reducing material and labor costs. These and other advantages of the invention will be apparent from the drawings, discussion and description which follow.

### BRIEF DESCRIPTION OF THE INVENTION

Disclosed herein is a constrained layer, composite structure for damping acoustic vibrations in an article. The composite structure includes an extensional layer of a first polymeric material. The first polymeric material has a first modulus of elasticity. In the use of the composite structure, the extensional layer is disposed upon a surface of an article in which acoustic vibrations are to be damped. The structure further includes a constraining layer of a second polymeric material which has a modulus of elasticity which is greater than the modulus of elasticity of the first polymeric material. The constraining layer is disposed atop the extensional layer. In some instances, the constraining layer may cover all of the extensional layer, while in other instances it may cover only a portion of the extensional layer.

In particular instances, the modulus of elasticity of the constraining layer is at least one order of magnitude greater than that of the modulus of elasticity of the material comprising the extensional layer. The first polymeric material may comprise a viscoelastic polymer. In particular instances, at least one of the polymeric materials is a thermally curable material, and these thermally curable materials may be nonhydroscopic and/or pumpable prior to being thermally cured.

The first polymeric material may comprise a mixture of synthetic rubber, a tackifier, an epoxy resin, a vinyl resin, and a thermally activated crosslinker. The second polymeric material may comprise a mixture of an epoxy resin, an elastomeric modifier, a tackifier, and a thermally activated crosslinker. One or more of the polymeric materials may include a flexibilizing reactive diluent, an inorganic filler, a reinforcing fiber, a foaming agent, and/or hollow microspheres.

In particular instances, the thickness of the extensional layer is in the range of 1-6 mm, while in some particular instances, the thickness of this layer is in the range of 2-4 mm. The thickness of the constraining layer may be in the range of 0.5-3 mm, and in particular instances in the range of 0.5-1.0 mm. In specific instances, the thickness of the extensional layer is greater than the thickness of the constraining layer. In particular embodiments, the loss factor of the composite structure is greater than 0.1 for frequencies in the range of 200-800 Hz.

Also disclosed herein are methods for the manufacture of the constrained layer, composite, acoustic vibration damping structures of the present invention. These methods may include use of coating techniques such as extrusion coating, shoveling, spray coating, and swirl coating, either singly or in combinations for the deposition of one or more of the layers. In specific instances, one or both of the layers may be deposited by a robotic coating apparatus.

### DETAILED DESCRIPTION OF THE INVENTION

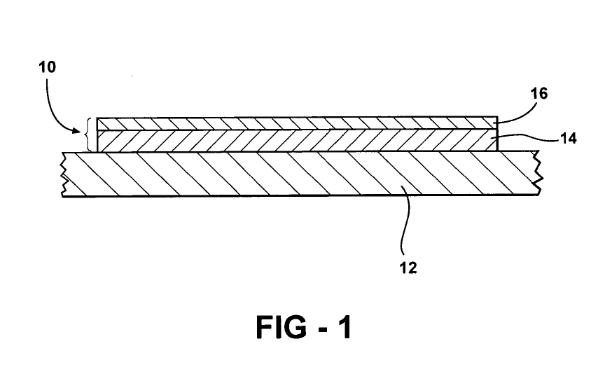

The present invention is directed to a constrained layer, composite strucuture used for damping acoustic vibrations in articles such as motor vehicle body panels and other sheet metal structures. The damping material of the present invention includes at least two layers of polymeric material; and referring now to FIG. 1, there is shown one embodiment of a composite acoustic damping structure of the present invention 10 as disposed upon a substrate 12 which may comprise a body of sheet metal in which acoustic vibrations are to be dampened. As will be seen, the acoustic damping structure 10 includes a first layer 14, also referred to as an extensional layer, which is disposed upon the substrate 12, and a second layer 16, also referred to as a constraining layer, which is disposed atop the first layer.

The first layer 14 and second layer 16 are both comprised of polymeric materials. The polymeric material of the first layer 14 is relatively soft compared to the material of the second layer 16. As such, the polymeric material of the second layer has a modulus of elasticity which is greater than that of the first layer 14. This combination of layers gives a high degree of acoustic and vibrational damping, and has also been found to increase the flexural strength of a panel to which it is attached. In specific instances, the modulus of elasticity of the second layer 16 is at least an order of magnitude greater than that of the first layer 14, and in particular instances, the modulus of the second layer 16 is at least several orders of magnitude greater than that of the first. It has been found that this combination of materials produces a synergistic effect which greatly enhances the ability of the material to attenuate acoustic vibrations over a wide range of frequencies.

In specific instances, the relative thicknesses of the two layers 14 and 16 are selected so that the first layer is thicker than the second layer 16. Acoustic damping generally increases as the softness and/or thickness of the first layer increases. Damping increases to a lesser degree with increasing thicknesses of the second layer. In particular embodiments, the thickness of the first layer 14 is in the general range of 1-6 mm. In some particular instances, the thickness of the first layer is in the range of 2-6 mm, while in other instances it is in the range of 2-4 mm. Typical thickness ranges for the second layer are 0.5-33 mm, and one particular range is 0.5-1.0 mm.

There are a variety of polymeric materials which may be employed in the practice of the present invention. In one specific group of embodiments, the polymeric material of the first layer 14 is comprised of a viscoelastic polymer. As is known in the art, viscoelastic polymeric materials have mechanical properties such that when a deforming force is applied thereto, they respond with hybrid characteristics corresponding to a resilient, spring-like component, as well as a viscous damping, dashpot-like component. There are a variety of polymeric materials known in the art which provide this characteristic behavior. The second material is of a more rigid nature. While not wishing to be bound by speculation, the inventors hereof assume that this combination of layers traps and attenuates acoustic vibrations in a very efficient manner.

In particular embodiments of the present invention, the polymeric materials comprising the two layers are thermally cross-linkable polymers which may be applied in a first, relatively soft, viscous form and subsequently cured by the application of heat to produce a harder material. In such instances, the various materials may be readily applied by automated bulk coating techniques. For example, uncured coatings may be applied to the articles by extrusion techniques, spray techniques, swirl techniques, or the like.

In one specific embodiment, coatings are readily applied by a technique called “shoveling.” This technique is an extrusion-type coating process in which material is dispensed as a sheet, directly onto the surface being coated. Such automated techniques may be employed for the deposition of one or both of the layers. In those instances where curable coatings are employed, these coatings may be cured right after application, or they may be subsequently cured, concomitant with further processing of the article. For example, the coatings may be dispensed onto a shaped body panel which is subsequently primed or painted, and the coating will be cured when the paint or primer is oven baked. In specific embodiments of the present invention, the compositions of the layers are formulated so that the uncured polymeric materials are non-hydroscopic, stable and adherent to the coated article. In this manner, the steps of applying the sound attenuating layers may be implemented early on in the manufacturing process, thereby simplifying placement and application of the materials. The mechanical and environmental stability of the uncured coatings allows for delayed cure without loss of properties.

In some particular embodiments, the material comprising the first, extensional layer includes compositions of a synthetic rubber, a tackifier, an epoxy resin, and a thermally activated crosslinker. In some instances, the composition may also include a vinyl resin, which may be a curable vinyl resin.

The composition of the constraining layer, in some instances, may comprise an epoxy resin, an elastomeric modifier, a tackifier, and a thermally activated crosslinker. The second composition may also include a flexibilizing active diluent as well as ancillary ingredients such as an inorganic filler, reinforcing fibers such as glass fibers, carbon fibers, or polymeric fibers. Either of the layers may also include a foaming agent, hollow microspheres of glass, ceramic, or a polymer, and other such ancillary ingredients.

The compositions of the present invention show very good sound attenuation over a wide frequency range. In general, the structures of the present invention exhibit a loss factor which is greater than 0.1, as measured at frequencies of 200, 400 and 800 Hz. This is considered to very good sound attenuation. In particular instances, loss factor values of 0.24-0.25 have been demonstrated utilizing relatively thin layers configured in accord with the present invention.

The materials of the present invention are compatible with a wide variety of substrates and have been demonstrated to have very good adherence to steel substrates at temperatures as low as −35° C., as was verified by standardized Cold Slam and Cold Bend tests. In addition to providing very good acoustic damping, it has been found that the materials of the present invention enhance the corrosion resistance of articles to which they are applied. The layers are resistant to metal treatment fluids typically encountered in the fabrication of motor vehicles and the like. Such fluids include phosphate and E-coat conditioners. Hence, these compositions can be applied to articles prior to surface finishing steps such as painting and the like. “Read through” is a problem typically encountered when structures are applied to the backside of painted, or to be painted, panels. Read through results when the presence of the applied article alters various characteristics of the panel, such as expansibility, thermal conductivity, or the like so that a paint film applied to the opposite face of the article is distorted in a corresponding pattern. It is notable that the acoustic damping structures of the present invention do not produce read through.

In view of the teaching presented herein, various combinations of materials may be readily selected by one of skill in the art so as to produce effective, constrained layer, acoustic damping structures. Some specific examples of materials which may be used to form the extensional and constraining layers of the present invention are as follows.

A first embodiment of extensional layer material comprises, on a weight percentage basis, 15% of a diglycidyl ether of bisphenol A such as the material sold under the designation NPEL 128E by the Nanya corporation; 10% asphalt such as the material sold under the designation Zeco 9000 by the Ziegler corporation; 30% calcium carbonate such as the material sold under the designation #10 white by the Imerys corporation; 5.2% mica such as the material sold under the designation mica 150 S by the Sutrite corporation; 15% styrene-butadiene rubber such as the material sold under the designation 1009 SBR by the ISP corporation; 0.1% carbon black such as the material sold under the designation Raven 410 by the Columbian corporation; 2.1% wollastonite such as the material sold under the designation Nyad M200 by the Nyco corporation; 1% fumed silica such as the material sold under the designation Cabosil PTG by the Cabot corporation; 1% dicyandiamide such as the material sold under the designation Dyhard 100S by the Degussa corporation; 1.5% of cashew nutshell liquid polymer with epichlorohydrin such as the material sold under the designation Lapox RA913 by the Royce corporation; 3% of a trifunctional epoxidized castor oil such as the material sold under the designation GE 35 by CVC Chemicals; 6% of an adduct of dimer acid and diglycidyl ether of bisphenol A such as the material sold under the designation Hypox RA 323 by CVC Chemicals; and 10% of a hydrocarbon tackifier resin such as the material sold under the designation Piccotac 1102 by the Eastman corporation.

A second formulation for the extensional layer comprises, on a weight basis, 2% of a liquid EPDM resin such as the material sold under the designation Trilene 65 by the Crompton corporation; 15% of the aforementioned asphalt; 18.4% of the aforementioned calcium carbonate; 15% of the aforementioned mica; 2% of the aforementioned wollastonite; 10% of talc such as the material sold under the designation Vertal 97 by the Luzenac corporation; 0.1% of the aforementioned carbon black; 1% of fumed silica; 2.5% of PVC resin; 3% of zinc diacrylate such as the material sold under the designation SR 633 by the Sartomer corporation; 6% of a diisononyl phthalate plasticizer having a molecular weight of approximately 420 such as the material sold under the designation 9P plasticizer by the BASF corporation; 10% of the aforementioned diglycidyl ether of bisphenol A; a rubber such as the material sold under the designation Tektane 100 by the Bayer corporation.

A third formulation of a material which may be used to form an extensional layer comprises, on a weight basis, 5% of the aforementioned liquid EPDM resin; 11.3% of the aforementioned asphalt; 25% calcium carbonate; 15% mica; 2% wollastonite; 20% of a polybutene resin such as the material sold under the designation Indopol H100 by the BP corporation; 0.1% carbon black; 0.1% fumed silica; 5.5% of the aforementioned zinc diacrylate; 6% of the aforementioned diisononyl phthalate plasticizer; and 10.3% of butyl rubber such as the material sold under the designation Butyl 065 by Exxon Mobil.

A fourth example of material which may be used for the extensional layer comprises, on a weight percentage basis, 2% of crosslinked butyl rubber such as the material sold under the designation Kalar 5215 by the Elementis corporation; 3% of the aforementioned butyl rubber; 5% of a C5 tackifier resin such as the material sold under the designation Escorez 1102 by the Exxon Mobil corporation; 10% calcium carbonate; 10% mica; 30% of a calcium carbonate sold under the designation #10 white by the Imerys corporation; 30% of the aforementioned polybutene resin; 5% of a diluent such as the material sold under the designation OLO by the Gage Products Corporation; and 5% of the aforementioned diisononyl phthalate plasticizer.

A fifth material which may be used for the fabrication of the extensional layer comprises, on a weight basis, 5% of dipropylene glycol diacrylate such as the material sold under the designation SR 508 by the Sartomer corporation; 10% of isobornyl acrylate such as the material sold under the designation SR 506D by the Sartomer corporation; 10% tetrahydrofurfuryl acrylate such as the material sold under the designation SR 285 by the Sartomer corporation; 5% carboxylated nitrile rubber such as the material sold under the designation Nipol 1472 by the Zeon corporation; 10% of the aforementioned diisononyl phthalate plasticizer; 47% calcium carbonate; 10% mica; 2% fumed silica; and 1% of dicumyl peroxide such as the material sold by various sources under the name Dicup 40C.

Yet another composition useful as an extensional layer comprises, on a weight basis, 10% of a blocked isocyanate resin; 50% of polypropylene glycol having an approximate molecular weight of 2000; 35% calcium carbonate; and 5% of a thixotropic agent sold under the designation R202 by the Degussa corporation. Blocked isocyanates which may be used in the present invention are well known to those of skill in the art, and one particular composition which may be employed comprises, on a weight percentage basis, 35% polytetramethylene glycol; 25% diisodecyl phthalate; 15% MDI, methyldiisocyante, together with 0.1 ml of an agent sold under the designation Dabco T-12. This composition is heated for three hours at 80° C. under a nitrogen atmosphere, and cooled to 50°, and blended with 25% methyl ethyl ketoxime. Other compositions of blocked isocyanate may be likewise employed in this composition.

In view of the foregoing, yet other embodiments of material usable in the extensional layer will be readily apparent to those of skill in the art.

A first example of material which may be used for fabricating the constraining layer comprises, on a weight basis, 4% of an aromatic hydrocarbon resin such as the material sold under the designation Nevex 100 by the Neville corporation; 25.7% of the aforementioned diglycidyl ether of bisphenol A; 12.8% of a diglycidyl ether of polypropylene glycol such as the material sold under the designation NPEL 032 by the Nanya corporation; 6.5% of the aforementioned cashew nutshell liquid polymer with epichlorohydrin; 4.3% mica; 8.6% wollastonite; 30% calcium carbonate; 4.3% of a slag wool fiber such as the material sold under the designation PMF fiber by Sloss Industries; 0.4% titanium dioxide; 1.8% fumed silica; and 3.2% of a curing agent such as the material sold under the designation 100S by the Degussa corporation.

A second formulation for the constraining layer comprises, on a weight basis, 10% of the aforementioned diglycidyl ether of bisphenol A; 20% of a low Tg polyester resin such as the material sold under the designation Dynapol S 320 by the Degussa corporation; 10% of the aforementioned diglycidyl ether of polypropylene glycol; 5% of the aforementioned cashew nutshell liquid polymer with epichlorohydrin; 36% calcium carbonate; 15% mica; 3% amorphous silica; and 1% of a curing agent sold under the designation 100S by the Degussa corporation.

A third formulation for the constraining layer comprises, on a weight basis, 20% of a thermoplastic urethane resin such as the material sold under the designation Desmopan 9370 AR by the Bayer corporation; 20% of the aforementioned diglycidyl ether of bisphenol A; 10% of the aforementioned diglycidyl ether of polypropylene glycol; 5% of the aforementioned cashew nutshell liquid polymer with epichlorohydrin; 26% calcium carbonate; 15% mica; 3% amorphous silica; and 1% of the curing agent sold under the designation 100S by the Degussa corporation.

In view of the foregoing, yet other modifications and variations of formulations for the constraining layer will be apparent to those of skill in the art.

A series of representative composite structures were prepared and tested utilizing extensional layers corresponding to Example 1 and constraining layers corresponding to Example 1. It was found that damping properties, as measured by the composite loss factor at 25°, increased with increasing thickness of the constraining layer. For example, a 2 mm thick layer produces a composite loss factor in the resulting structure of 0.05; a 4 mm thick layer produces a composite loss factor of 0.08; and a 6 mm thick layer produces a composite loss factor of 0.11. Increasing thicknesses of the constraining layer do not have as large an effect on the composite loss factor. A 2 mm thick constraining layer produces a composite loss factor of 0.05; a 4 mm thick layer produces a composite loss factor of 0.09; and a 6 mm thick layer produces a composite loss factor of 0.16. The constraining layer can also serve as a reinforcement member for the scale panels. Typically, bare steel of 0.8 mm thickness has a flexural strength (N) of 40-45. When coated with a composite structure having a 2 mm thick constrained layer, its flexural strength increases to 50-55. When the thickness of the constrained layer is increased to 3 mm, the flexural strength is 60-65, and remains at that value if the thickness is increased to 4 mm.

The respective thicknesses of the constrained layer and extensional layer (also referred to as the soft layer) can be selected for particular applications in view of the teaching presented herein. Table 1 hereinbelow details loss factors at different frequencies, for damping structures of the present invention including layers of various thicknesses.

TABLE 1

| Total | Ratio of Soft/ | | | | |
|---|---|---|---|---|---|
| Thickness | Constraining | | Loss Factor | | |
| (mm) | Layers | Cure Conditions | 200 Hz | 400 Hz | 800 Hz |
| 6.2 | 3:1 | 375° F. 20 min. | 0.250 | 0.252 | 0.288 |
| 4.6 | 2:1 | 375° F. 20 min. | 0.202 | 0.184 | 0.242 |
| 3.6 | 1:1 | 375° F. 20 min. | 0.154 | 0.157 | 0.164 |
| 4.1 | 2:1 | 400° F. 40 min. | 0.164 | 0.199 | 0.251 |
| 3.8 | 2:1 | 400° F. 40 min. | 0.146 | 0.165 | 0.180 |
| 3.2 | 2:1 | 400° F. 40 min. | 0.126 | 0.125 | 0.121 |

Table 2 summarizes vibration damping properties of a structure corresponding generally to the first entry of Table 1, as measured at various temperatures and frequencies. Measurements were conducted in accord with procedure SAE J1637.

TABLE 2

| Test Temperature | Resonant Frequency Hz | Loss Factor |
|---|---|---|
| −10° C. | 200 | 0.036 |
| | 400 | 0.041 |
| | 800 | 0.050 |
| 10° C. | 200 | 0.071 |
| | 400 | 0.070 |
| | 800 | 0.077 |
| 25° C. | 200 | 0.250 |
| | 400 | 0.252 |
| | 800 | 0.288 |
| 40° C. | 200 | 0.230 |
| | 400 | 0.231 |
| | 800 | 0.242 |
| 60° C. | 200 | 0.156 |
| | 400 | 0.208 |
| | 800 | 0.274 |
| 80° C. | 200 | 0.046 |
| | 400 | 0.059 |
| | 800 | 0.079 |

As will be seen from the foregoing, the compositions of the present invention provide a very high degree of damping of a broad spectrum of acoustic vibrations over a temperature range corresponding to that normally encountered in the use of motor vehicles. In view of the teaching presented herein, the properties of the composite structure can be adjusted to accommodate specific temperate ranges as well as specific acoustic profiles, as may be encountered in various applications. For example, the composite structure of the present invention can be optimized for use in watercraft, home appliances, aircraft, static building structures and the like.

While the foregoing description has concerned structures comprising two layers of material, it is understood that the present invention is not to be limited thereto. In accordance with the present invention, multilayered structures may be likewise implemented. For example, a composite sound attenuating structure may include a plurality of stacked combinations of extensional layers and constraining layers. For example, a structure of 4-6 alternating layers of first and second polymeric material may be readily deposited, particularly by automated deposition techniques. Also, while the two layers are shown as being generally coextensive in FIG. 1, it is understood that other variations within the scope of the present invention here, for example, a sound attenuating structure may comprise an extensional layer of the first relatively soft polymer disposed on the article, and a constraining layer disposed on the first layer wherein the constraining layer is configured so as to cover only a portion of the first layer. In specific instances, the constraining layer may be configured as a series of strips or crosshatched members. In other instances, a continuous or discontinuous constraining layer may be interposed between subjacent and superjacent layers of relatively soft extensional material. All such embodiments are within the scope of the present invention.

In view of the teaching present herein, yet other modifications and variations will be apparent to those of skill in the art. The foregoing drawings, discussion and examples are illustrious of a specific embodiment of the invention, but are not meant to be limitations upon the practice thereof. It is the following claims, including all equivalents, which define the scope of the invention.

1. A constrained layer, composite structure for damping acoustic vibrations in an article, said composite structure comprising:
an extensional layer of a first polymeric material, said first polymeric material having a first modulus of elasticity, wherein in the use of said composite structure, said extensional layer is disposed upon a surface of an article in which acoustic vibrations are to be damped; and
a constraining layer of a second polymeric material which has a modulus of elasticity which is greater than the modulus of elasticity of said first polymeric material, said constraining layer being disposed atop said extensional layer.

2. The composite structure of claim 1, wherein the second modulus of elasticity is at least one order of magnitude greater than the first modulus of elasticity.

3. The composite structure of claim 1, wherein said first polymeric material is a viscoelastic polymer.

4. The composite structure of claim 1, wherein at least one of said first polymeric material and said second polymeric material is a thermally curable polymeric material.

5. The composite structure of claim 1, wherein said first polymeric material comprises a mixture of: synthetic rubber, a tackifier, an epoxy resin, a vinyl resin, and a thermally activated crosslinker.

6. The composite structure of claim 1, wherein said second polymeric material comprises a mixture of: an epoxy resin, an elastomeric modifier, a tackifier, and a thermally activated crosslinker.

7. The composite structure of claim 1, wherein at least one of said first and said second polymeric materials further includes one or more of: a flexibilizing reactive diluent, an inorganic filler, a reinforcing fiber, a foaming agent, and hollow microspheres.

8. The composite structure of claim 4, wherein at least one of said first polymeric material and said second polymeric material are non-hydroscopic prior to being thermally cured.

9. The composite structure of claim 4, wherein at least one of said first and second polymeric material are pumpable prior to being thermally cured.

10. The composite structure of claim 1, wherein the thickness of said extensional layer is in the range of 1-6 mm, and the thickness of said constraining layer is in the range of 0.5-3 mm.

11. The composite structure of claim 1, wherein the thickness of said extensional layer is in the range of 2-4 mm, and the thickness of said constraining layer is in the range of 0.5-1.0 mm.

12. The composite structure of claim 1, wherein the thickness of said extensional layer is greater than the thickness of said constraining layer.

13. The composite structure of claim 1, wherein the loss factor of said composite structure is greater than 0.1 for frequencies in the range of 200-800 Hz.

14. A method for providing a constrained layer, composite, acoustic vibration damping structure on an article, said method comprising the steps of:
applying an extensional layer of a first polymeric material onto said article, said first polymeric material having a first modulus of elasticity; and
applying a constraining layer of a second polymeric material atop said extensional layer, said second polymeric material having a second modulus of elasticity which is greater than said first modulus of elasticity.

15. The method of claim 14, wherein said first and second polymeric materials are thermally curable, and wherein said first and second polymers are applied in said uncured form and subsequently cured by heating.

16. The method of claim 14, wherein at least one of said extensional layer and said constraining layer is applied by coating techniques selected from the group consisting of extrusion coating, shoveling, spray coating, swirl coating, and combinations thereof.

17. The method of claim 14, wherein at least one of said extensional layer and said constraining layer is applied by a robotic coating apparatus.

18. The method of claim 14, wherein said first polymeric material is any one of the materials described in claims 1-13.

19. The method of claim 14, wherein said second polymeric material is any one of the materials described in claims 1-13.

20. The method of claim 14, wherein said article comprises a component of a motor vehicle.
